(19) United States
(12) Patent Application Publication
(10) Pub. No.: US 2020/0230917 A1
(43) Pub. Date: Jul. 23, 2020

(54) HOT-FORMING COMPOSITE MATERIAL, PRODUCTION THEROF, COMPONENT, AND USE THEREOF

(71) Applicants: ThyssenKrupp Steel Europe AG, Duisburg (DE); thyssenkrupp AG, Essen (DE)

(72) Inventors: Janko BANIK, Altena (DE); Stefan MYSLOWICKI, Monchengladbach (DE); Matthias SCHIRMER, Dusseldorf (DE)

(73) Assignees: ThyssenKrupp Steel Europe AG, Duisburg (DE); thyssenkrupp AG, Essen (DE)

(21) Appl. No.: 16/652,790

(22) PCT Filed: Oct. 6, 2017
(86) PCT No.: PCT/EP2017/075463

§ 371 Date: Apr. 1, 2020

(51) Int. Cl. B32B 15/01; C22C 38/28; C22C 38/06; B21D 22/02

(52) U.S. Cl. CPC B32B 15/011; C22C 38/28; B32B 2255/20; B21D 22/022; B32B 2255/06; C22C 38/06

(57) ABSTRACT

The invention relates to a hot-forming composite material (1) composed of an at least three-layer material composite comprising a core layer (1.1) of a hardenable steel and two outer layers (1.2), cohesively bonded to the core layer (1.1), of a ferritic, transformation-free FeAlCr steel.

### TECHNICAL FIELD

The invention relates to a hot-forming composite material composed of an at least three-layer material composite.

### BACKGROUND ART

The automotive industry is searching for new solutions for reducing vehicle weight and hence for reducing fuel consumption. Lightweight construction is an important factor here in order to be able to reduce the vehicle weight. One way of achieving this is by the use of materials having enhanced strength. The bending capacity thereof generally decreases with rising strength. In order to ensure the requisite occupant protection in the crash-relevant components as well for achievement of lightweight construction in spite of enhanced strength, it has to be ensured that the materials used can convert the energy introduced by a crash by deformation. This requires a high degree of forming capacity, especially in the crash-relevant components of a vehicle structure. One way of saving weight is, for example, to configure or to build the bodywork and/or the chassis of a land vehicle in even lighter manner by means of innovative materials compared to the conventionally used materials. For example, conventional materials can be replaced in a component-specific manner by materials having lower wall thicknesses with comparable properties. For example, the automotive industry is making ever greater use of hybrid materials or material composites composed of two or more different materials, each individual material having particular properties, including some opposing properties, that are combined in the material composite in order to achieve improved properties in the material composite by comparison with the individual monolithic materials. Material composites, especially made of different steels, are known in the art, for example from German published specification DE 10 2008 022 709 A1 and European published specification EP 2 886 332 A1.

A steel composite material designed for hot forming is being sold by the applicant under the “Tribond®” 1200 and 1400 trade name. An ultrahigh-strength, hardenable steel is used as core layer, and a ductile steel as outer layers in different material thicknesses, in order to achieve the aim of high strength and ductility. In order to achieve acceptable residual forming capacity in the press-hardened state in the case of such material pairs, a high material thickness of the ductile composite partner is envisaged. This reduces the strength of the material composite in two ways: firstly, it is the ductile component itself that leads to this; secondly, the strength of the core is lowered since diffusion flows of the alloy elements between the composite partners occur in the course of manufacturing (hot roll cladding) and processing (hot forming). For example, carbon diffuses from the core layer into the outer layer, hardens it and at the same time lowers the strength in the core region. When thin outer layers are used, a high overall strength is achieved, but the diffusion processes result in comparatively significant hardening of the ductile composite partner, such that the ductility targets ultimately cannot be attained.

In the hot-forming operation, the steel composite materials mentioned at the outset are cut into blanks and heated to austenitization temperature in order then to simultaneously hot-form and cool them in a cooled mold (direct hot forming). Alternatively, the blanks can first be formed while cold to give a preliminary form, the preliminary form can be heated and can then be hot-formed in a cooled mold to give a finished form, especially calibrated and cooled (indirect hot forming). Intensive cooling, wherein cooling rates of at least 27 K/s are required when a 22MnB5 is used as core layer, transforms the microstructure of austenite completely to martensite, and the material processed to the component, in the press-hardened state, receives its desired high strength in the core layer. This process is also known among specialists by the name “press hardening”. The steel composite materials used for the purpose have been provided with an aluminum-based coating, for example an AlSi coating, in order to prevent unwanted scale formation in the course of heating of the steel blank to austenitization temperature.

The prior art additionally discloses steel composite materials having a hardenable core layer consisting of a steel and outer layers of stainless steels, especially chromium steel; see, for example, DE 10 2014 116 695 A1 and WO 2012/146384 A1. These material composites are insensitive to hydrogen-induced cracking (delayed fracture), especially in the case of use of core layers having high strengths. The use of chemically stable steels (chromium steel) as outer layers can achieve the aim of corrosion protection for the component produced from the material composite, more particularly without having to apply additional aluminum-based or zinc-based coatings prior to the press hardening. In the case of integration of such a component, for example in a vehicle structure, contact with adjoining components made of chemically unstable steel, for example carbon steel, forms a galvanic element that leads to enhanced corrosion attack on the components made of carbon steel. In the case of such a component combination in a vehicle structure, therefore, it would be necessary to take complex additional anticorrosion measures that prevent the forming of a galvanic element or protect the components consisting of carbon steel in some other way. Furthermore, this can result in adverse effects for the component manufactured from a material composite having outer layers of chemically stable stainless steels if the stainless steel outer layer were to be locally damaged, for example, by stonechipping. This too would result in the possibility of formation of a galvanic element. However, the endangerment of the component formed from the material composite by corrosive attack, owing to the size of the anode (small damaged region) relative to the cathode (large intact surface region), would be much greater compared to the above-described case of the component combination. As well as a high strength greater than 1400 MPa, averaged over the total material thickness of the material composite or of a component in the press-hardened state, a sufficient residual ductility which is described in terms of the bending angle attained in the 3-point bending test (VDA 238-100), a possibility of inductive rapid heating, an insensitivity toward hydrogen-induced cracking and sufficient corrosion protection, the material composite or the component in the press-hardened state should also have good paintability of the surface.

Chemically stable steels (chromium steels), by comparison with hardenable steels, depending on the alloy elements thereof and in a temperature-dependent manner, have a lower degree of expansion characteristics, such that hot-forming composite materials can be produced in a reliable process only at high cost and inconvenience, for example by hot roll cladding.

### SUMMARY OF INVENTION

It is an object of the invention to provide an improved and easily producible hot-forming composite material compared to the prior art.

This object is achieved by a hot-forming composite material having the features of patent claim 1. Further advantageous embodiments of the invention are detailed in the dependent claims.

The inventors have established that a hot-forming composite material composed of at least a three-layer composite material comprising a core layer of a hardenable steel, especially with a carbon content C of at least 0.06% by weight, especially at least 0.12% by weight, preferably at least 0.2% by weight, and two outer layers, cohesively bonded to the core layer, of a ferritic, transformation-free FeAlCr steel, especially having an aluminum content Al between 2% and 9% by weight and a chromium content Cr between 0.1% and 12% by weight, is provided, which firstly has the aforementioned advantages, especially in that it can be press-hardened by means of inductive rapid heating, and secondly essentially compensates for the aforementioned disadvantages, especially in that it has the problems with regard to corrosion described under use conditions as a component in the press-hardened state in a vehicle structure only to a reduced degree, if at all. By means of an FeAlCr steel as outer layers with a ferritic, transformation-free lattice structure, the alloy elements, especially from an electrochemical point of view, are essentially no different or only slightly different from the conventionally used carbon steels in a vehicle structure.

The hot-forming composite material or the material composite has been produced by means of cladding, especially roll cladding, preferably hot roll cladding, or by means of casting. The hot-forming composite material of the invention has preferably been produced by means of hot roll cladding, as disclosed, for example, in German patent specification DE 10 2005 006 606 B3. Reference is made to this patent specification, the content of which is hereby incorporated into this application. Alternatively, the hot-forming composite material of the invention can be produced by means of casting, one means of production thereof being that disclosed in Japanese published specification JP-A 03 133 630. Metallic material composite production is common knowledge from the prior art.

Especially with regard to the production of the hot-forming composite material by means of preferred hot roll cladding, the outer layers of FeAlCr steel used benefit the process temperatures, for example the rolling end temperature and coiling temperature, by comparison with chemically stable steels (chromium steels), which facilitates compliance with critical temperature requirements, especially within a defined process window.

The outer layers of FeAlCr steel used, in the hot rolling operation in the preferred hot roll cladding process, have an advantage over a chemically stable steel (chromium steel) in terms of thermal expansion characteristics. Firstly, the (fully) ferritic and hence transformation-free FeAlCr steel is of excellent suitability as outer layer material since it ideally averages the varying coefficient of expansion of the core layer of hardenable steel in the ferrite-austenite transformation. Thus, the use of outer layers of FeAlCr steel results in lower thermal stresses, for example in the weld seams in the bonding of individual layers to form packs (slab packs), compared to (fully) ferritic, chemically stable steels composed of chromium steel. This increases process reliability for production of the hot-forming material. Secondly, in an effect in the same manner, the difference in expansion characteristics up to 700° C. is generally smaller.

The hot-forming material may be made or provided to the further process steps in strip form, plate form or sheet form. The hot-forming material may thus be integrated into existing standard hot-forming processes without having to make changes in the process chain.

In a first preferred configuration of the hot-forming composite material, the ferritic, transformation-free FeAlCr steel of the outer layers, as well as Fe and unavoidable impurities from the production, consists of, in % by weight,

C: up to 0.15%,

Al: 2% to 9%,

Cr: 0.1% to 12%,

Si: up to 2%,

Mn: up to 1%,

Mo: up to 2%,

Co: up to 2%

P: up to 0.1%,

S: up to 0.03%,

Ti: up to 1%,

Nb: up to 1%,

Zr: up to 1%,

V: up to 1%,

W: up to 1%.

The figures for the alloy elements relate more particularly to the state (state as supplied) prior to the production of the material composite.

C is present at a maximum of 0.1% by weight, especially a maximum of 0.01% by weight. C contributes to enhancing the strength in the outer layers. The smaller the amount of C, the more ductile the outer layers will be and the higher the bending angle of the hot-forming composite material or of the component in the press-hardened state can be. The minimum content is 0.001% by weight.

Al is present at at least 2% by weight and at at most 9% by weight, especially at most 7% by weight, preferably at most 6% by weight, more preferably at most 5.5% by weight, in order more particularly to promote weldability and corrosion protection. The minimum content of 2% by weight, especially of at least 3% by weight, preferably of at least 4% by weight, in combination with Cr, leads to a stable ferritic lattice structure in the outer layers. Below 2% by weight, freedom from transformation, especially in the heating in the course of the hot rolling of the hot-forming composite material and also in the course of press hardening, is no longer assured. Furthermore, Al has an advantageous effect in the processing of the hot-forming composite material, especially by press hardening, since a thin, stable aluminum oxide layer that provides corrosion protection forms on the surface. This aluminum oxide layer that consists essentially of Al₂O₃ and may include accompanying elements, for example SiO₂, TiO₂ and/or Cr₂O₃, may also have the further positive effect that it is possible to dispense with blasting of the components after the press hardening and prior to a painting operation, since it is formed with very firm adhesion to the surface of the hot-forming composite material.

Mn is an austenite former and is therefore limited to a maximum of 1% by weight. Mn with a content of at least 0.01% by weight, especially of at least 0.02% by weight, can have a positive effect on the adjustment of strength. Mn may also be present merely as an impurity and/or normal accompanying element.

Cr is a ferrite former and serves to bind C that has diffused in from the core layer and is present at at least 0.1% by weight, especially at least 2% by weight, preferably at least 3% by weight, and is limited to a maximum of 12% by weight, especially a maximum of 9% by weight, preferably a maximum of 7% by weight. Cr in combination with Al has a ferrite-stabilizing effect and promotes freedom from transformation. Another effect of a lower chromium content compared to chemically stable steels is that the electrochemical difference from the conventional carbon steels under use conditions and from the core layer is smaller. The driving force for the occurrence of corrosion processes is thus significantly reduced.

As well as corrosion resistance, Cr also influences the weldability of a material. This relates not only to processing of a press-hardened component made of the hot-forming composite material of the invention and, for example, also the preferred production thereof in the construction of the required packs for hot roll cladding. Contents above the limits lead to unwanted passivation, as known from chemically stable steels (chromium steels).

Mo is limited to a maximum of 2% by weight and may also more particularly be limited to a maximum of 1% by weight, preferably a maximum of 0.5% by weight, since Mo is a costly alloy element. Mo may also be present solely as an impurity and/or normal accompanying element.

Co is limited to a maximum of 2% by weight and may also especially be limited to a maximum of 1% by weight, preferably a maximum of 0.5% by weight, since Co is a costly alloy element. Co may also be present solely as an impurity and/or normal accompanying element.

P or S are alloy elements which, individually or in combination, if they are not included in the alloy specifically for establishment of specific properties, may be counted among the impurities. The contents are limited to a maximum of 0.1% by weight of P and to a maximum of 0.03% by weight of S.

Furthermore, it may be advantageous when a proportion of Ti, Nb, Zr, V and/or W that adds up to greater than the unavoidable impurities from production is present, where the alloy elements are each limited to a maximum of 1% by weight, and may especially be in the range from 0.1% to 2% by weight, preferably 0.25% to 1.5% by weight and more preferably 0.3% to 1.2% by weight, based on the total amount of Ti, Nb, Zr, V and W. In this case, it is not necessary for the FeAlCr steel to contain all five of the alloy elements mentioned; instead, it is also possible that the content results from just one, two, three or four of the alloy elements mentioned. The elements Ti, Nb, Zr, V and W, by virtue of their preferred binding to N compared to Cr, ensure that the ferrite-forming free Cr content is not reduced by nitride formation. Moreover, these alloy elements can bind C, such that the formation of brittle kappa-carbides (Fe—Al carbides) can be avoided. Ti, Nb, Zr, V and/or W may also be present solely as an impurity and/or normal accompanying element. The FeAlCr steel is preferably Nb-free.

Illustrative representatives of FeAlCr steels having a ferritic, transformation-free microstructure are known, for example, from the applicant's published specification WO 2013/178629 A1.

In a further configuration of the hot-forming composite material, the hardenable steel of the core layer, as well as Fe and unavoidable impurities from the production, consists of, in % by weight,

C: 0.06-0.8%,

Si: up to 0.5%,

Mn: 0.5-3%,

P: up to 0.06%,

S: up to 0.03%,

Al: up to 0.2%,

Cr+Mo: up to 1%,

Cu: up to 0.2%,

N: up to 0.01%,

Nb+Ti: up to 0.2%,

Ni: up to 0.4%,

V: up to 0.2%,

B: up to 0.01%,

As: up to 0.02%,

Ca: up to 0.01%,

Co: up to 0.02%,

Sn: up to 0.05%.

The figures for the alloy elements are especially based on the state (state as supplied) prior to the production of the material composite.

C is a strength-enhancing alloy element and contributes to an increase in strength with increasing content, such that a content of at least 0.06% by weight, especially of at least 0.12% by weight, preferably of at least 0.2% by weight, further preferably of at least 0.28% by weight, further preferably of at least 0.33% by weight, further preferably of at least 0.37% by weight, especially preferably of at least 0.42% by weight, is present, in order to achieve or establish the desired strength. Brittleness also increases with higher strength, and so the content is limited to a maximum of 0.8% by weight, especially a maximum of 0.75% by weight, preferably a maximum of 0.68% by weight, further preferably a maximum of 0.65% by weight, especially preferably a maximum of 0.62% by weight, in order not to adversely affect the material properties and to assure sufficient weldability.

Si is an alloy element that contributes to solid solution hardening and, according to its content, has a positive effect in an increase in strength, and so a content of at least 0.05% by weight is present. The alloy element is limited to a maximum of 0.5% by weight, especially a maximum of 0.45% by weight, preferably a maximum of 0.4% by weight, in order to ensure sufficient rollability.

Mn is an alloy element that contributes to hardenability and to increasing the processing time in the hot-forming process by retarding transformation and has a positive effect on tensile strength, especially for binding of S to form MnS, and so a content of at least 0.5% by weight is present. The alloy element is limited to a maximum of 3% by weight, especially a maximum of 2.5% by weight, preferably a maximum of 2.2% by weight, in order to ensure sufficient weldability. In conjunction with a C content of less than 0.2% by weight, especially of less than 0.12% by weight, Mn is included in the alloy at at least 1.5% by weight, especially at at least 1.7% by weight, in order to ensure hardenability. If C is present at at least 0.2% by weight, Mn can be reduced to a maximum of 2% by weight, especially a maximum of 1.5% by weight.

Al as alloy element can contribute to deoxidation, where a content at at least 0.01% by weight, especially at 0.015% by weight, may be present. The alloy element is limited to a maximum of 0.2% by weight, especially a maximum of 0.15% by weight, preferably a maximum of 0.1% by weight, in order to essentially reduce and/or avoid precipitates in the material, especially in the form of nonmetallic oxidic inclusions that can have an adverse effect on the material properties. For example, the content may be set between 0.02% and 0.06% by weight.

Cr as alloy element, according to its content, may also contribute to adjustment of strength, especially contribute positively to hardenability, for example with a content of at least 0.05% by weight. The alloy element is limited to a maximum of 1% by weight, especially a maximum of 0.8% by weight, preferably a maximum of 0.7% by weight, in order to ensure sufficient weldability.

B as alloy element may contribute to hardenability and increased strength, especially when N is bound, and may be present at a content of at least 0.0008% by weight, especially of at least 0.001% by weight. The alloy element may be limited to a maximum of 0.01% by weight, especially to a maximum of 0.008% by weight, since higher contents have an adverse effect on the material properties and would result in a reduction in hardness and/or strength in the material.

Ti and Nb as alloy elements may be included individually or in combination for grain refining and/or N binding, especially when Ti is present at a content of at least 0.005% by weight. For complete binding of N, the Ti content would have to be provided at at least 3.42*N. The alloy elements in combination are limited to a maximum of 0.2% by weight, especially a maximum of 0.15% by weight, preferably a maximum of 0.1% by weight, since higher contents have an adverse effect on the material properties, especially adverse effect on the toughness of the material.

Mo, V, Cu, Ni, Sn, Ca, Co, As, N, P or S are alloy elements that, individually or in combination, if they are not specifically included in the alloy for adjustment of specific properties, can be counted among the impurities. The contents are limited to a maximum of 0.2% by weight of Mo, to a maximum of 0.2% by weight of V, to a maximum of 0.2% by weight of Cu, to a maximum of 0.4% by weight of Ni, to a maximum of 0.05% by weight of Sn, to a maximum of 0.01% by weight of Ca, to a maximum of 0.02% by weight of Co, to a maximum of 0.02% by weight of As, to a maximum of 0.01% by weight of N, to a maximum of 0.06% by weight of P, to a maximum of 0.03% by weight of S.

The hardenable steel of the core layer of the hot-forming composite material in the press-hardened state has a tensile strength >500 MPa and/or a hardness >170 HV10, especially a tensile strength >1300 MPa and/or a hardness >450 HV10, preferably a tensile strength >1700 MPa and/or a hardness >500 HV10, further preferably a tensile strength >1900 MPa and/or a hardness >575 HV10, especially preferably a tensile strength >2100 MPa and/or a hardness >630 HV10. HV corresponds to the Vickers hardness and is ascertained to DIN EN ISO 6507-1:2005 to −4: 2005. If the tensile strength, for example, is above 1000 MPa, especially above 1300 MPa, the microstructure in the press-hardened state may consist, for example, at least to an extent of 90%, preferably at least to an extent of 95%, further preferably at least to an extent of 98%, of martensite and/or a mixed martensite-bainite microstructure, and may also contain ferrite in the transition region to the core layer. In the case of a tensile strength below 1000 MPa, there is a corresponding reduction in the proportion of martensite and/or the mixed martensite-bainite microstructure.

Illustrative representatives of hardenable steels are commercially available steels from the group of DIN standard DIN EN 10883-2, for example of the C22, C35, C45, C55, C60 quality, manganese-containing steels (DIN EN 10883-3), especially of the 20MnB5, 30MnB5, or 37MnB5, 42CrMo4 quality according to DIN EN 10263-4, and further qualities, for example 20MnB8, 22MnB5, 40MnB4, and also case-hardened steels or air-hardening steels.

In a further configuration of the hot-forming composite material, the outer layers each have a material thickness of <22%, especially <17%, preferably <12%, more preferably <9%, based on the total material thickness of the hot-forming composite material. The outer layers each have a material thickness of at least 1%, especially at least 2%, preferably at least 4%, more preferably at least 5%, per side based on the total material thickness of the hot-forming composite material. The hot-forming composite material or the three-layer material composite has a total material thickness between 0.5 and 8.0 mm, especially between 0.8 and 5.0 mm and preferably between 1.2 and 4.0 mm.

In a second aspect, the invention relates to a process for producing a hot-rolling-clad hot-forming composite material composed of an at least three-layer material composite comprising a core layer of a hardenable steel and two outer layers, cohesively bonded to the core layer, of a ferritic, transformation-free FeAlCr steel, said process comprising the following steps:
providing a layer of a hardenable steel and at least two layers of a ferritic, transformation-free FeAlCr steel,
stacking the layers provided in such a way that the layer of the hardenable steel forms a core layer and the two layers of the ferritic, transformation-free steel as outer layers receive the core layer between them,
cohesively bonding the edges at least in some regions between the individual layers to produce a preliminary composite, especially by means of welding,
heating the preliminary composite in a furnace to at least 1200° C.,
hot rolling the heated preliminary composite in one or more steps to give a coilable hot strip,
optionally cold rolling the hot strip in one or more steps to give a cold strip.

The procedure for production of a hot-forming composite material may be analogous to the teaching of DE 10 2005 006 606 B3. Prior to the stacking of the individual layers, the surfaces of the layers may each be subjected to a cleaning operation to remove extraneous materials on the surface and/or a material-removing processing operation, especially for establishment of a predefined planarity. The layers are assembled, for example, in the form of sheets, plates, preliminary slabs or slabs. The layer of hardenable steel and the layers of FeAlCr steel preferably include the chemical alloy elements as defined further up. All the aforementioned advantages are also applicable in association with the process of the invention for production of a hot-forming composite material.

In a third aspect, the invention relates to a component produced from a hot-forming composite material of the invention by means of press hardening or a multistage hot-forming process, especially for production of a component for automobile construction, train construction, shipbuilding or aerospace. The press hardening can be effected by means of direct or indirect hot forming. A multistage hot-forming process is understood to mean a hot forming operation in at least two molds and/or in at least two operation stages with optional trimming and subsequent press hardening. Reference is made by way of example to EP 3 067 128 A1. More particularly, the component after the press hardening or multistage hot-forming process has an aluminum oxide layer, especially with a thickness up to 1000 nm, especially up to 300 nm, preferably up to 200 nm, more preferably up to 150 nm.

In a fourth aspect, the invention relates to use of a component produced from the hot-forming composite material of the invention in the bodywork or in the chassis of a land vehicle. The vehicles are preferably passenger vehicles, utility vehicles or buses, whether with an internal combustion engine or purely electrically operated or hybrid-operated vehicles. The components may be used as longitudinal beams, transverse beams or columns in a land vehicle; for example, they take the form of profiles, especially of a crash profile in the bumper, sill, side impact member, or in regions in which zero to low deformation/intrusion is required in the event of a crash, or may take the form of a wishbone, stabilizers or rear torsion beam axle in the chassis region.

### BRIEF DESCRIPTION OF DRAWINGS

The invention is elucidated in detail hereinafter with reference to a drawing. The drawing shows:

FIG. 1) a schematic section through a hot-forming composite material of the invention.

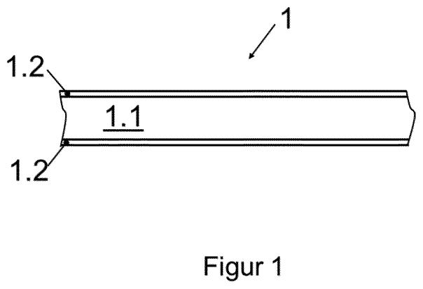

### BEST MODE FOR CARRYING OUT THE INVENTION

The sole FIGURE shows a schematic section diagram through a hot-forming composite material (1) of the invention. The hot-forming composite material (1) of the invention comprises a core layer (1.1) of a hardenable steel having a carbon content C of at least 0.06% by weight, which, in the press-hardened state, has a tensile strength >500 MPa and/or a hardness >170 HV10, especially a tensile strength >1300 MPa and/or a hardness >450 HV10, preferably a tensile strength >1700 MPa and/or a hardness >520 HV10, further preferably a tensile strength >1900 MPa and/or a hardness >575 HV10, two outer layers (1.2), cohesively bonded to the core layer (1.1), of a ferritic, transformation-free FeAlCr steel having an aluminum content Al between 3% and 7% by weight and a chromium content Cr between 0.1% and 12% by weight. The material thickness of the outer layers (1.3) is at least 1% and at most 22%, preferably at least 4% and at most 12%, per side, based on the total material thickness of the hot-forming composite material (1), where the hot-forming composite material (1) may have, for example, a total material thickness between 0.5 and 8 mm.

Commercial flat steel products were used to produce, by means of hot roll cladding, a hot-forming composite material that had a three-layer material composite. The outer layers used were a steel designated Fe-5.4Al-6Cr-0.04Ti, and the core layer used was a hardenable steel designated 37MnB5.

In each case, sheet blanks (slabs) were stacked one on top of another to form a core layer with two outer layers, which were cohesively bonded to one another, preferably by means of welding, along their edges at least in some regions to form a preliminary composite. By virtue of the lower Cr content compared to chemically stable steels (chromium steels), it was possible to produce the pack construction in a less complex manner. The preliminary composite was brought to a temperature of >1200° C. in a furnace and hot-rolled in multiple steps to give a material composite having a total material thickness of 3 mm and then processed further to give a 1.5 mm cold strip.

Blanks were divided off from the hot-formed composite material. The blanks were heated or through-heated by means of induction to austenitization temperature, especially above A_{c3} (based on the core layer), and then, in a cooled mold, hot-formed to give components and cooled. The cooling rates were >30 K/s.

By means of EDX analysis by scanning electron microscope, the components produced were examined in detail, and essentially no increase in hardening, i.e. no increase in the concentration of carbon in the outer layers, was detected. Over the cross section of the core layer, a carbon profile had formed with an essentially higher concentration of carbon in the edge region (close to the interface) than in the middle of the core layer. At the transition between the two layers, there was enrichment of a C-rich phase. By virtue of the outer layers consisting of a ferritic, transformation-free lattice structure with corresponding carbon solubility, it was possible to freeze diffusion of the carbon out of the core layer by means of the free chromium in the outer layers, essentially close to the interface in the form of chromium carbides. In the region further from the interface in the direction of the center or middle of the core layer, there was essentially no change in the chemical alloy elements by comparison with the original state or state as supplied.

The core layer was composed essentially entirely of martensite over the thickness and, at the transition to the outer layer, the microstructure additionally contained proportions of bainite and/or ferrite. The outer layer essentially retained its original microstructure that it had at the time of provision prior to the manufacture of the material composite and the further processing to form a component, and so there was no transformation. The outer layers of FeAlCr steel used have a positive influence on the bending properties of the material composite or hot-forming composite material since, in addition to intrinsic low strength and hence high ductility, they offer the option of influencing ongoing diffusion processes such that regions having lower strength are formed in the core layer of the material composite that previously had high strength throughout. The material thickness of the outer layers was 6% per side, based on the total material thickness of the hot-forming composite material, such that the core layer had a material thickness of 88% based on the total material thickness. The thickness of the aluminum oxide layer formed on the surface of the in the course of press hardening was less than 150 nm.

The invention is not limited to the working example shown in the drawing. Instead, the hot-forming composite material of the invention may also be part of a tailored product, for example part of a tailored welded blank and/or tailored rolled blank, and may also have more than three layers. In addition, a component may also be produced by means of a multistage hot-forming process.

1. A hot-forming composite material comprising: an at least three-layer material composite comprising a core layer of a hardenable steel and two outer layers, cohesively bonded to the core layer, of a ferritic, transformation-free FeAlCr steel.

2. The hot-forming composite material as claimed in claim 1, wherein the ferritic, transformation-free FeAlCr steel of the outer layers, aside from Fe and unavoidable impurities from the production, consists of, in % by weight,
C: up to 0.15%,
Al: 2% to 9%,
Cr: 0.1% to 12%,
Si: up to 2%,
Mn: up to 1%,
Mo: up to 2%,
Co: up to 2%
P: up to 0.1%,
S: up to 0.03%,
Ti: up to 1%,
Nb: up to 1%,
Zr: up to 1%,
V: up to 1%,
W: up to 1%.

3. The hot-forming composite material as claimed in claim 2 wherein the hardenable steel of the core layer, aside from Fe and unavoidable impurities from the production, consists of, in % by weight,
C: 0.06-0.8%,
Si: up to 0.5%,
Mn: 0.4-3%,
P: up to 0.06%,
S: up to 0.03%,
Al: up to 0.2%,
Cr+Mo: up to 1%,
Cu: up to 0.2%,
N: up to 0.01%,
Nb+Ti: up to 0.2%,
Ni: up to 0.4%,
V: up to 0.2%,
B: up to 0.01%,
As: up to 0.02%,
Ca: up to 0.01%,
Co: up to 0.02%,
Sn: up to 0.05%.

4. The hot-forming composite material as claimed in claim 3 wherein the steel of the core layer has a carbon content between 0.28-0.75% by weight.

5. The hot-forming composite material as claimed in claim 3 wherein the outer layers each have a material thickness between 1% and 22%, based on the total material thickness of the hot-forming composite material.

6. The hot-forming composite material as claimed in claim 5 wherein the material composite has been produced by means of one of cladding and casting.

7. The hot-forming composite material as claimed in claim 5 wherein the hot-forming composite material is part of one of a tailored product, a tailored welded blank and a tailored rolled blank.

8. A method for producing a hot-rolling-clad hot-forming composite material comprising at least three-layer material composite comprising a core layer of a hardenable steel and two outer layers, cohesively bonded to the core layer, of a ferritic, transformation-free FeAlCr steel, the method comprising the following steps:
providing a layer of a hardenable steel and at least two layers of a ferritic, transformation-free FeAlCr steel,
stacking the layers provided in such a way that the layer of the hardenable steel forms a core layer and the two layers of the ferritic, transformation-free steel as outer layers receive the core layer between them,
cohesively bonding the edges at least in some regions between the individual layers to produce a preliminary composite, especially by means of welding,
heating the preliminary composite in a furnace to at least 1200° C., and;
hot rolling the heated preliminary composite in one or more steps to give a coilable hot strip.

9. A component produced from a hot-forming composite material by means of one of a press hardening and a multistage hot-forming process, the component comprising:
a core layer of a hardenable steel and two outer layers cohesively bonded to the core layer of a ferritic, transformation-free FeAlCr steel wherein the ferritic transformation-free FeAlCr steel of the outer layers, aside from Fe and unavoidable impurities from the production, consists of, in % weight,
C: 0.06-0.8%,
Si: up to 0.5%,
Mn: 0.4-3%,
P: up to 0.06%,
S: up to 0.03%,
Al: up to 0.2%,
Cr+Mo: up to 1%,
Cu: up to 0.2%,
N: up to 0.01%,
Nb+Ti: up to 0.2%,
Ni: up to 0.4%,
V: up to 0.2%,
B: up to 0.01%,
As: up to 0.02%,
Ca: up to 0.01%,
Co: up to 0.02%,
Sn: up to 0.05%.

10. The component as claimed in claim 9, wherein the component after the press hardening or multistage hot-forming process has an aluminum oxide layer.

11. The component as claimed in claim 10, wherein the component is one of a bodywork and chassis of a land vehicle.

12. The hot-forming composite material as claimed in claim 4 wherein the steel of the core layer has a carbon content between 0.33-0.68% by weight.

13. The hot-forming composite material as claimed in claim 5 wherein the outer layers each have a material thickness between 2% and 17% based on the total material thickness of the hot-forming composite material.

14. The hot-forming composite material as claimed in claim 13 wherein the outer layers each have a material thickness between 4% and 12% based on the total material thickness of the hot-forming composite material.

15. The method of claim 8, further comprising:
cold rolling the hot strip in at least one step to give a cold strip.
